(19) United States
(12) Patent Application Publication
(10) Pub. No.: US 2014/0223236 A1
(43) Pub. Date: Aug. 7, 2014

(54) DEVICE FOR TESTING A GRAPHICS CARD

(71) Applicant: NVIDIA Corporation, Santa Clara, CA (US)

(72) Inventors: Dongbo HAO, Shenzhen (CN); Tiecheng LIANG, Shenzhen (CN); Jie ZHOU, Shenzhen (CN)

(73) Assignee: NVIDIA Corporation, Santa Clara, CA (US)

(21) Appl. No.: 14/175,420

(22) Filed: Feb. 7, 2014

(30) Foreign Application Priority Data
Feb. 7, 2013 (CN) 201310049423.8

(51) Int. Cl. G06F 11/22

(52) U.S. Cl. CPC G06F 11/2236
USPC 714/31

(57) ABSTRACT

A device for testing a graphics card is presented. The device includes a core test apparatus. The core test apparatus includes a processor configured to perform a test operation on a graphics card and a power interface for transferring electric energy to the core test apparatus. Using the device for testing a graphics card provided by the present invention makes a graphics card test easier and more efficient.

### CROSS-REFERENCE TO RELATED APPLICATIONS

This application claims priority to Chinese Patent Application No. 201310049423.8, filed on Feb. 7, 2013, which is hereby incorporated by reference in its entirety.

### FIELD OF INVENTION

Embodiments of the present invention relate generally to graphics cards, and more particularly to a device for testing a graphics card.

### BACKGROUND

During the production of graphics cards, also referred to as graphics subsystems, it is needed to test the quality and the reliability of the graphics cards. A test of a graphics card includes testing for a number of parameters, for example, power consumption, power efficiency, reset reliability, etc. Usually, the above parameters are manually determined by employing a number of different systems and steps, and each test is performed separately from the others. Test results are usually manually collected and analyzed by testers. Therefore, the test of a graphics card goes through a complex process, requires more systems, is costlier and is time intensive.

What is needed in the art is a device capable of testing a graphics card more easily and efficiently.

### SUMMARY OF THE INVENTION

In one embodiment, a device for testing a graphics card is disclosed. The device includes a core test apparatus. The core test apparatus includes a processor configured to perform a test operation on a graphics card and a power interface for transferring electric energy to the core test apparatus.

Preferably, the device further includes an additional test apparatus and the core test apparatus further includes a first current path including a first galvanometer. A first power signal is transferred from an additional power source to the additional test apparatus via the first current path. The additional test apparatus is used to transfer the first power signal to the graphics card. The first galvanometer is configured to measure a current of the first power signal. The processor is further configured to calculate an input power of the graphics card according to the measured current.

Preferably, the core test apparatus further includes a second current path including a second galvanometer. A second power signal is transferred from the additional power source to the graphics card via the second current path. The second galvanometer is configured to measure a current of the second power signal.

Preferably, the core test apparatus includes one or more second current paths.

Preferably, the core test apparatus further includes a communication port. The processor is further configured to receive a load current value and a load voltage value from an external load of the graphics card via the communication port, calculate an output power of the graphics card according to the load current value and the load voltage value and calculate a power efficiency of the graphics card according to the input power and the output power.

Preferably, the core test apparatus further includes a serial bus interface. The processor is further configured to transfer the input power to an external computer via the serial bus interface so as to calculate an output power of the graphics card according to a load current value and a load voltage value received from an external load of the graphics card and calculate a power efficiency of the graphics card according to the input power and the output power by the external computer. The load current value and the load voltage value are programmed by the external computer.

Preferably, the core test apparatus further includes a serial bus interface. The processor is further configured to compare the input power with a predetermined power value, and send an instruction to change a voltage of a graphics processing unit on the graphics card to a motherboard via the USB interface according to the compared result to obtain a desired voltage. The motherboard is communicatively coupled with the graphics card via the additional test apparatus.

Preferably, the core test apparatus further includes a serial bus interface. The processor is further configured to compare the input power with a predetermined power value, send an instruction to change a frequency of a graphics processing unit on the graphics card to a motherboard via the USB interface according to the compared result to obtain a desired frequency. The motherboard is communicatively coupled with the graphics card via the additional test apparatus.

Preferably, the device further includes an additional test apparatus. The core test apparatus further includes a first current path including a first power switch. A first power signal is transferred from an additional power source to the additional test apparatus via the first current path. The additional test apparatus is used to transfer the first power signal to the graphics card. The first power switch is used to control enable time for transferring the first power signal from the additional power source to the graphics card according to a first control signal from the processor.

Preferably, the core test apparatus further includes a second current path including a second power switch. A second power signal is transferred from the additional power source to the graphics card via the second current path. The second power switch is used to control enable time for transferring the second power signal from the additional power source to the graphics card according to a second control signal from the processor.

Preferably, the core test apparatus includes one or more second current paths.

Preferably, respective control signals allow enable time for transferring respective power signals to the graphics card to be in a desired sequence.

Preferably, the core test apparatus further includes Input/Output (I/O) pins for being connected with power on headers and/or reset headers on a motherboard communicatively coupled with the graphics card. The processor is configured to transfer a I/O signal for controlling a reset operation of the graphics card to the graphics card via the I/O pins.

Preferably, the graphics card is powered by the motherboard directly.

Preferably, the graphics card is powered by an additional power source via the core test apparatus.

Preferably, the I/O signal is a programmable pulse signal.

Preferably, the device further includes a display apparatus and the processor is configured to output testing information of the graphics card to the display apparatus to be displayed on the display apparatus.

Preferably, the display apparatus includes one or more on-screen buttons for adjusting the display of the testing information.

Preferably, the testing information is selected from a group including an input power, an output power and a power efficiency of the graphics card and a frequency and a voltage of a graphics processing unit of the graphics card.

Preferably, the core test apparatus further includes an Ethernet interface for receiving control information from an external device and/or transferring testing information of the graphics card from the processor to the external device.

A graphics card test may be easier and more efficient by using the device for testing a graphics card provided by the embodiments of the present invention.

Advantages and features of the present invention will be described in detail below in connection with the accompanying drawings.

### BRIEF DESCRIPTION OF THE DRAWINGS

In order that the advantages of the invention will be readily understood, a more detailed description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings.

FIG. 1 illustrates an exemplary circuit diagram of a core test apparatus in a device for testing a graphics card, according to an embodiment of the present invention;

FIG. 2 illustrates a functional block diagram of an additional test apparatus in a device for testing a graphics card and a motherboard communicatively coupled with the additional test apparatus, according to an embodiment of the present invention;

FIG. 3 illustrates a circuit schematic diagram of a core test apparatus, according to an embodiment of the present invention;

FIG. 4 illustrates an exemplary block diagram of a device for testing a graphics card and related devices communicatively coupled with the device, according to an embodiment of the present invention;

FIG. 5 illustrates an exemplary block diagram of a device for testing a graphics card and related devices communicatively coupled with the device, according to another embodiment of the present invention;

FIG. 6 illustrates an exemplary block diagram of a device for testing a graphics card and related devices communicatively coupled with the device, according to yet another embodiment of the present invention; and

FIG. 7 illustrates an exemplary block diagram of a device for testing a graphics card and related devices communicatively coupled with the device, according to yet another embodiment of the present invention.

### DETAILED DESCRIPTION

In the following discussion, details are presented so as to provide a more thorough understanding of the present invention. However, the present invention may be implemented without one or more of these details as would be apparent to one of ordinary skill in the art. Certain examples are illustrated without elaborate discussion of technical features that would be within the purview of one of ordinary skill in the art so as to avoid confusion with the present invention.

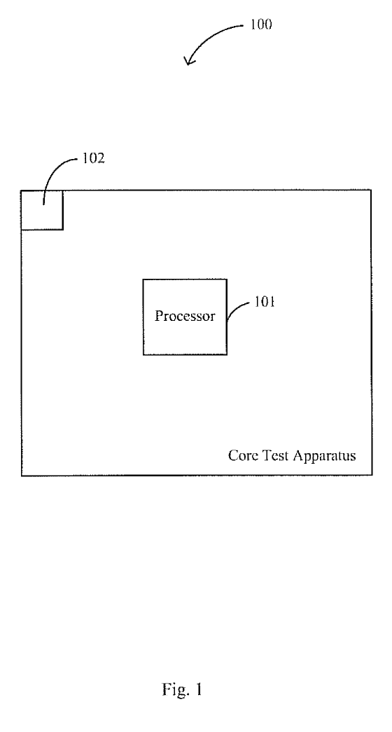

Embodiments of the present invention disclose a device for testing a graphics card. The device for testing a graphics card includes a core test apparatus. FIG. 1 illustrates a schematic block diagram of a core test apparatus 100, according to an embodiment of the present invention. The core test apparatus 100 includes a processor 101 and a power interface 102. The processor 101 is configured to perform a test operation on a graphics card. The processor 101 may include an arithmetic unit and a control unit. The arithmetic unit is used to process and calculate data related to a test of the graphics card, and the control unit is used to issue various control commands to control operations of the arithmetic unit as needed. The processor 101 may also include a memory for storing programs, data and calculating results, etc., which are being used or usually used. The processor 101 may also include an internal bus for transferring information among various components within the processor. The information may include address information, control information and data information, etc. The processor 101 may employ any microprocessor known in the art. In a preferable embodiment, the processor 101 is an ARM processor, which has high performance, low cost, low energy consumption and convenience for development.

The power interface 102 is used to transfer electric energy to the core test apparatus 100. The power interface 102 may be connected to an external power source so that the core test apparatus 100 may be powered by the external power source. Alternatively, the core test apparatus 100 may also include system buses for transferring information between the processor 101 and other respective components of the core test apparatus 100. In an embodiment, the system buses are I2C buses, for example, which have advantages of a simple control mode, a small device package size, high communication speed, etc. Because the processor 101 is programmable and has strong computing ability, the test of the graphics card may be achieved on the device automatically and conveniently. Therefore, complicated manual operations are reduced during the test.

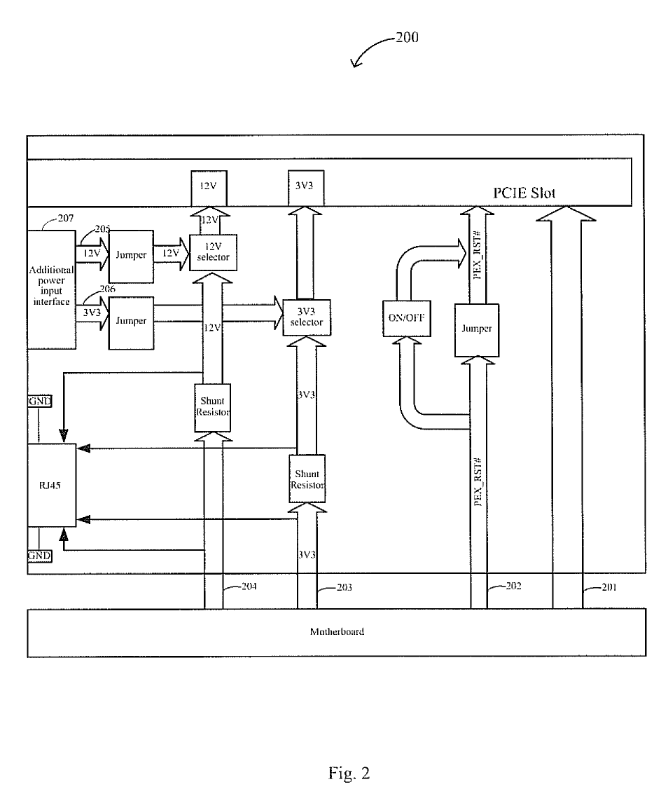

Alternatively, the device for testing a graphics card may further include an additional test apparatus. FIG. 2 illustrates a functional block diagram of an additional test apparatus 200 in a device for testing a graphics card and a motherboard communicatively coupled with the additional test apparatus, according to an embodiment of the present invention. The additional test apparatus 200 may include a motherboard interface, e.g. a PCIE 16X interface, which is used to connect with the motherboard and communicate with the motherboard. The additional test apparatus 200 may also include a graphics card interface slot, e.g. a PCIE interface slot, which is used to accommodate and couple to a graphics card and communicate with the graphics card. The additional test apparatus 200 may further include communication paths 201 and 202 for transferring control signals, clock signals, data signals and so on from the motherboard to the graphics card.

In an embodiment, the additional test apparatus 200 is used to transfer a first power signal from a core test apparatus 100 to the graphics card. The additional test apparatus 200 includes a current path 205, a current path 206 and an additional power input interface 207, for example, a 8Pin For Golden Finger PEX_{—}12V&PEX_{—}3V3 interface. The additional test apparatus 200 receives the first power signal from the core test apparatus 100 via the additional power input interface 207. The additional test apparatus 200 may receive two first power signals: 12V and 3.3V for instance. The above two first power signals may be transferred to the graphics card via the current path 205 and the current path 206 respectively. In another embodiment, the additional test apparatus 200 may include a current path 203 and a current path 204 for transferring two power signals from the motherboard to the graphics card respectively. Alternatively, the additional test apparatus 200 may choose to transfer the power signals from the motherboard or the power signals from the core test apparatus 100 to the graphics card by using a selector integrated within it. The power signals via the additional test apparatus are used to stimulate power signals directly provided to the graphics card by the motherboard, thus a current and an input power of the latter may be measured.

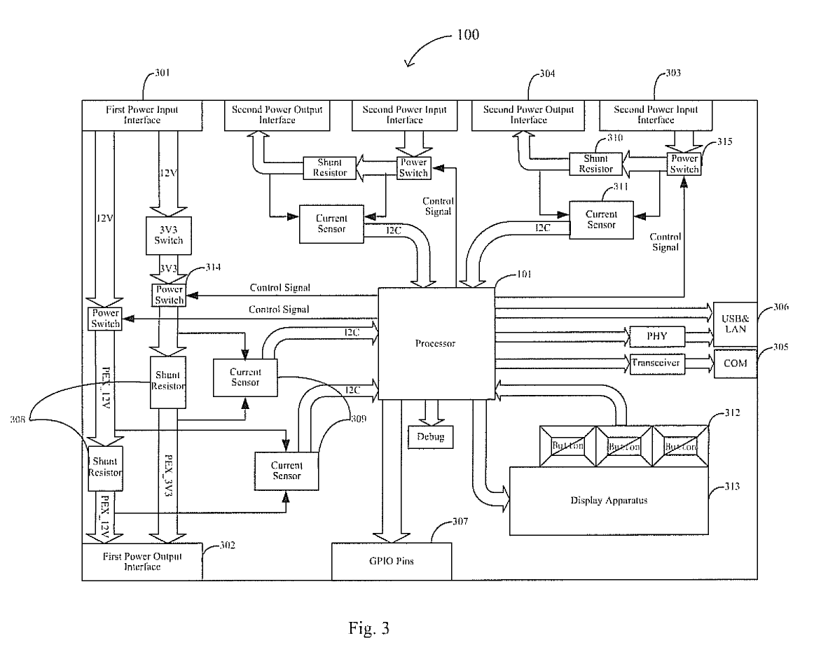

FIG. 3 illustrates an exemplary circuit schematic diagram of a core test apparatus 100, according to an embodiment of the present invention. The core test apparatus 100 may further include a first current path including a first galvanometer. A first power signal is transferred from an additional power source to the additional test apparatus 200 via the first current path. The additional test apparatus 200 is used to transfer the first power signal to the graphics card. According to the embodiment, the first current path may also include a first power input interface 301 and a first power output interface 302, for example, a 8Pin For Golden Finger PEX_{—}12V&PEX_{—}3V3 interface.

The first galvanometer may be configured to measure a current of the first power signal. In the embodiment, the first power signal may include two power signals, one of which may be converted from 12V to 3.3V, for instance, in the core test apparatus 100. The first current path may include two galvanometers for testing the current of each power signal respectively. In an embodiment, the first galvanometer may include a shunt resistor 308 and a current sensor 309. The shunt resistor 308 is provided in the first current path, thus the current through the shunt resistor 308 and the current through the graphics card are same in this current path. The current sensor 309, which is programmable, can measure a voltage across the shunt resistor 308 and then calculate the current through the shunt resistor 308, e.g. the current of the power signal provided to the graphics card via the first current path, according to the voltage and the resistance of the shunt resistor 308. The current sensor 309 may also be used to convert the current through the shunt resistor 308 from analog data to digital data, and transfer the digital data to the processor 101 via an I2C bus. The current sensor 309 may be, for example, an INA 219 sensor.

The processor 101 may be further configured to calculate an input power of the graphics card according to the measured current. When the processor 101 receives the digital data from the current sensor 309, e.g. the current value of the first power signal, the processor 101 may calculate the input power of the graphics card provided by the first power signal according to the current value and the voltage value of the first power signal. When the core test apparatus 100 includes only the first current path, the input power is equal to the power consumption of the graphics card. A power input to the graphics card by the motherboard may be measured by using the first power signal to stimulate the power signal input to the graphics card by the motherboard directly so as to calculate the power consumption of the graphics card.

Alternatively, the core test apparatus 100 may further include a second current path including a second galvanometer. The second current path may also include a second power input interface 303 and a second power output interface 304. A second power signal is transferred from an additional power source to the graphics card via the second current path. The second power signal may be of any voltage, for example 12V voltage, that applies to the graphics card. The second galvanometer may be configured to measure a current of the second power signal.

When the graphics card needs more power and the power supplied to the graphics card by the motherboard or the first power signal is not enough, an additional power source is used to provide an extra power to the graphics card. In an embodiment, the voltage of the second power signal is 12V. In an embodiment, the second galvanometer may include a shunt resistor 310 and a current sensor 311. The shunt resistor 310 is provided in the second power path, thus the current through the shunt resistor 310 and the current through the graphics card are same in this current path. The current sensor 311, which is programmable, can measure a voltage across the shunt resistor 310 and then calculate the current through the shunt resistor 310, e.g. the current of the power signal provided to the graphics card via the second current path, according to the voltage and the resistance of the shunt resistor 310. The current sensor 311 may also be used to convert the current through the shunt resistor 310 from analog data to digital data, and transfer the digital data to the processor 101 via an I2C bus.

The current sensor 311 may be, for example an INA 219 sensor. In the embodiment, the power consumption of the graphics card is equal to a sum of the power input to the graphics card by the first power signal plus the power input to the graphics card by the second power signal. The processor 101 is programmed to add the input power of the first power signal to the input power of the second power signal to calculate the power consumption of the graphics card. Existing middle and high end graphics cards typically have larger power consumption, and an addition of the second power signal may satisfy the demands of such graphics cards.

Alternatively, the core test apparatus 100 may include one or more second current paths. In an embodiment, the core test apparatus 100 includes two second current paths. The processor 101 may be programmed to calculate the sum of the input power of the first power signal and the input power of two second power signals, which is the power consumption of the graphics card. The input power of the graphics card may be further increased by using one or more second current paths to satisfy the demands of the graphics card for higher power consumption.

As above mentioned, the device may further include an additional test apparatus 200. The core test apparatus 100 may further include the first current path. As shown in FIG. 3, the first current path may include a first power switch 314. A first power signal is transferred from an additional power source to the additional test apparatus 200 via the first current path. The additional test apparatus 200 is used to transfer the first power signal to the graphics card. The first power switch 314 is used to control enable time for transferring the first power signal from the additional power source to the graphics card in accordance with a first control signal from the processor 101. An automatic control of powering on the graphics card may be achieved by using the processor 101 and the first power switch 314 to control the first current path to be on or off.

Alternatively, if there is a second current path in the core test apparatus 100, then the second current path may include a second power switch 315. A second power signal is transferred from the additional power source to the graphics card via the second current path. The second power switch 315 is used to control enable time for transferring the second power signal from the additional power source to the graphics card in accordance with a second control signal from the processor 101.

Alternatively, the core test apparatus 100 may include one or more second current paths. In an embodiment, the core test apparatus 100 includes two second current paths. The input power of the graphics card may be further increased by using one or more second current paths to satisfy the demands of the graphics card for higher power consumption.

Alternatively, respective control signals allow enable time for transferring respective power signals to the graphics card to be in a desired sequence. In an embodiment, respective control signals sent to respective power switches by the processor 101 allow respective power signals to be supplied to the graphics card in a particular sequence. Thereby the power on sequence of the graphics card may be controlled. The processor 101 may be programmable to change the power on sequence to test whether the graphics card can normally operate in different power on sequences.

Alternatively, the device for testing a graphics card may further include a display apparatus that may be integrated on the core test apparatus 100 or provided independently of the core test apparatus 100. A display apparatus 313 integrated on the core test apparatus 100 is shown in FIG. 3. It is beneficial for saving space and cost to integrate the display apparatus 313 on the core test apparatus 100. It is beneficial for maintenance and replacement of the display apparatus to provide the display apparatus independently. The processor 101 is configured to output testing information of the graphics card to the display apparatus to be displayed on the display apparatus. The testing information may be viewed in real time and visually by being displayed on the display apparatus directly, and the operation status may be known. Thus there is no need for users to operate manually, which is more convenient.

Alternatively, as shown in FIG. 3, the display apparatus may include one or more buttons for adjusting the display of the testing information. When the contents of the testing information are relatively significant in length and cannot be displayed in one frame completely, the displayed part of the testing information may be adjusted, for example by page turning, by using the one or more buttons, which is convenient for users to view the testing information.

Alternatively, the testing information is selected from a group including an input power, an output power and a power efficiency of the graphics card and a frequency and a voltage of a graphics processing unit of the graphics card. When the power on sequence of the graphics card is tested, the resting information may also include the operation status of the graphics card, that is, whether the graphics card are running normally, which may be determined by viewing whether the display contents of a display device communicatively coupled with the graphics card are normal.

Alternatively, the core test apparatus 100 may further include an Ethernet interface 306 for receiving control information from an external device and/or transferring testing information of the graphics card from the processor 101 to the external device. In an embodiment, when an external device is used for controlling the core test apparatus 100 to perform a test operation on the graphics card, the core test apparatus 100 may receive control information transferred by the external device via the Ethernet interface 306 and perform a corresponding test operation, such as testing a power consumption, a power efficiency, a power on sequence, a reset operation of the graphics card and a maximum voltage and a maximum frequency of a graphics processing unit on the graphics card, according to the control information. In another embodiment, the core test apparatus 100 may also transfer the testing information of the graphics card to a remote external device via the Ethernet interface 306 for using the testing information on the external device, thereby enabling users to perform a related operation on the graphics card remotely.

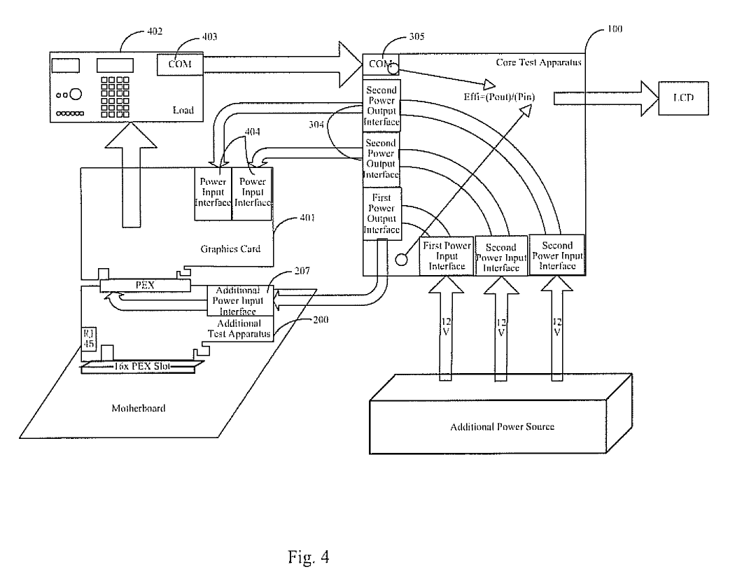

Alternatively, the core test apparatus 100 may further include a communications port, e.g., COM port 305. The processor 100 may be further configured to receive a load current value and a load voltage value from an external load of the graphics card via the COM port 305, calculate an output power of the graphics card according to the load current value and the load voltage value and calculate a power efficiency of the graphics card according to the input power and the output power. FIG. 4 illustrates an exemplary block diagram of the device for testing a graphics card and related devices communicatively coupled with the device, according to an embodiment of the present invention. As shown in FIG. 4, the related devices may include a graphics card 401, an external load 402 of the graphics card 401 and so on. In an embodiment, a second power signal is output to the graphics card 401 via a second power output interface 304 of the core test apparatus 100 and a power input interface 404 of the graphics card 401. The graphics card 401 does not include a graphics processing unit, and the graphics processing unit is stimulated by the external load 402 to test the power efficiency of the graphics card 401 in different operation modes. The current and the voltage of the external load 402 may vary to stimulate the current and the voltage of the graphics processing unit in different operation modes. The COM port 305 may be connected to a COM port 403 of the external load 402 so that the processor 101 in the core test apparatus 100 receives a current value and a voltage value of the external load 402 in a particular operation mode. The power consumption of the external load 402 is equal to the output power of the graphics card 401. Therefore, the processor 101 may calculate the power consumption of the external load 402 according to the current value and the voltage value of the external load 402, and then the output power of the graphics card 401 may be obtained. The input power of the graphics card 401 may be calculated according to the above mentioned method. The power efficiency of the graphics card 401 may be calculated according to the input power and the output power. The processor may be allowed to directly obtain the required load current value and load voltage value via the COM port 305, thus obtaining the power efficiency of the graphics card in different operation modes.

Alternatively, the core test apparatus 100 may further include a serial bus, e.g., universal serial bus (USB) interface 306. The processor 101 may be further configured to transfer the input power to an external computer via the USB interface 306 so as to calculate an output power of the graphics card according to a load current value and a load voltage value received from an external load of the graphics card and calculate a power efficiency of the graphics card according to the input power and the output power by the external computer. The load current value and the load voltage value may be programmed by the external computer.

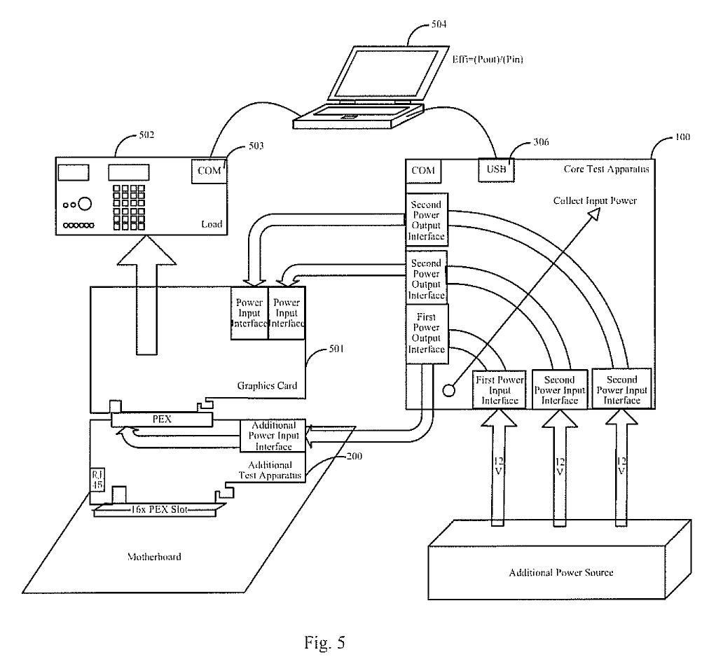

FIG. 5 illustrates an exemplary block diagram of the device for testing a graphics card and related devices communicatively coupled with the device, according to another embodiment of the present invention. As shown in FIG. 5, the related devices may include a graphics card 501, an external load 502 of the graphics card, an external computer 504 and so on. The graphics card 501 does not include a graphics processing unit, and the graphics processing unit is stimulated by the external load 502 to test the power efficiency of the graphics card 501 in different operation modes. The external computer 504 is connected to a COM port 503 of the external load to receive the current value and the voltage value of the external load 502 in a particular operation mode. The external load 502 may be programmed by the external computer 504 to change the current and the voltage of the external load 502. In addition, the external computer may also receive the input power of the graphics card 501 from the processor 101 via the USB interface 306 of the core test apparatus 100, and then calculate the power efficiency of the graphics card 501 according to the input power and the output power of the graphics card 501. The external computer 504 may also be programmed to automatically generate a power efficiency report according to the calculated power efficiency and display the power efficiency report on a screen of the external computer 504. It is more convenient, quicker and easier to change the current and the voltage of the external load by using the external compute. The manual operation time of engineers may be saved and testing results are conveniently viewed by generating a power efficiency report by the external computer automatically.

Alternatively, the above USB interface 306 may also be used to connect to a USB interface of a motherboard communicatively coupled with the graphics card so that the core test apparatus 100 may communicate with the motherboard. The processor 101 may be further configured to compare the input power of the graphics card with a predetermined power value, and send an instruction to change a voltage or a frequency of a graphics processing unit on the graphics card to a motherboard via the USB interface 306 according to the compared result to obtain a desired voltage or a desired frequency respectively.

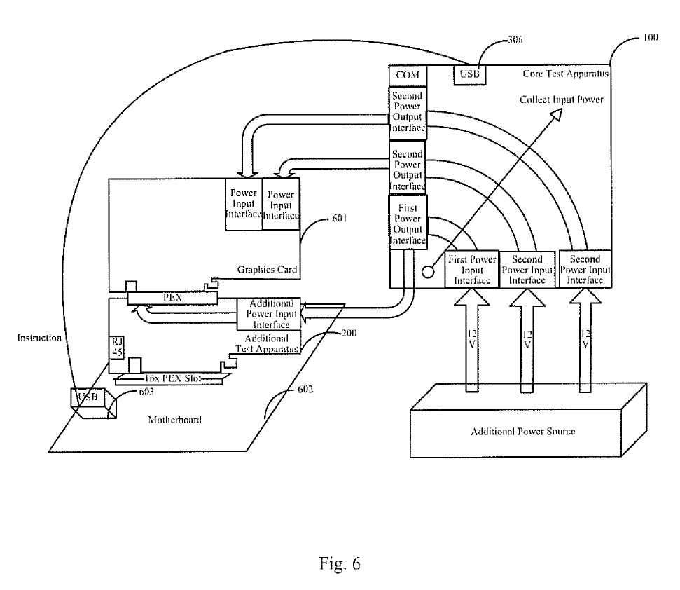

FIG. 6 illustrates exemplary block diagram of the device for testing a graphics card and related devices communicatively coupled with the device, according to yet another embodiment of the present invention. As shown in FIG. 6, the related device may include a graphics card 601, a motherboard communicatively coupled with the graphics card 601 and so on. The USB interface 306 of the core test apparatus 100 is connected to a USB interface 603 of the motherboard 602. In an embodiment, the processor 101 compares the input power of the graphics card 601 with a certain predetermined power value after calculating the input power. If the input power is less than the predetermined power value, the processor 101 sends an instruction to the motherboard 602 to increase the voltage of the graphics processing unit step by step by an Application Program Interface under the condition that the frequency of the graphics processing unit is constant. After each change of the voltage of the graphics processing unit, the input power is retested, until the input power is equal to the predetermined power value, thereby obtaining a maximum voltage of the graphics processing unit at a fixed frequency.

In another embodiment, the processor 101 compares the input power of the graphics card 601 with a certain predetermined power value after calculating the input power. If the input power is less than the predetermined power value, the processor 101 sends an instruction to the motherboard 602 to increase the frequency of the graphics processing unit step-by-step by an Application Program Interface, for instance, under the condition that the voltage of the graphics processing unit is constant. After each change of the frequency of the graphics processing unit, the input power is retested, until the input power is equal to the predetermined power value, thereby obtaining a maximum frequency of the graphics processing unit at a fixed voltage.

In one embodiment, it is more convenient that the processor 101 is programmed to compare the input power of the graphics card with a predetermined power value. It is beneficial to test the maximum voltage or the maximum frequency of the graphics processing unit that the processor 101 communicates with the motherboard.

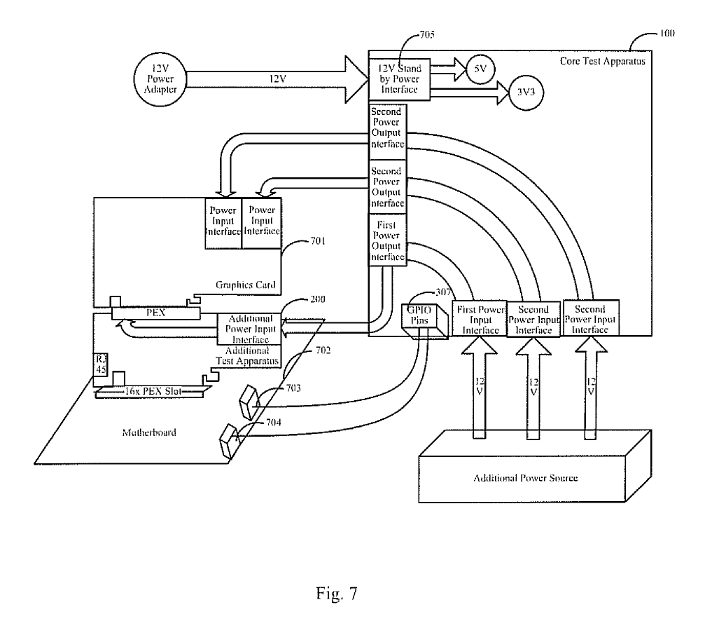

Alternatively, the core test apparatus 100 may further include input/output pins, e.g. graphics processor input/output (GPIO) pins 307 for being connected with power on headers and/or reset headers on a motherboard communicatively coupled with the graphics card. The processor 101 is configured to transfer a GPIO signal for controlling a reset operation of the graphics card to the graphics card via the GPIO pins 307. FIG. 7 illustrates an exemplary block diagram of the device for testing a graphics card and related devices communicatively coupled with the device, according to yet another embodiment of the present invention. As shown, the related devices may include a graphics card 701, a motherboard 702 communicatively coupled with the graphics card 701 and so on. The motherboard 701 is connected with an additional power source. The GPIO pins 307 of the core test apparatus 100 connect with power on headers 703 and/or reset headers 704 so that the processor 101 may transfer the GPIO signal to the motherboard 702. The motherboard 702 may turn on or turn off the additional power source according to the GPIO signal to control the graphics card 701 to be reset, thereby testing the stability of the graphics card 701 while being reset.

Alternatively, the GPIO signal is a programmable pulse signal. The highest value, the lowest value and the cycle of the GPIO signal may be programmed to change the GPIO signal input to the motherboard and a reset cycle of the graphics card. It can make the device complete a reset test of the graphics card automatically by using the processor 101 to set the GPIO signal as a pulse signal. Thereby the stability of the graphics card in case of being reset repeatedly may be detected. This method may save human intervention cost effectively.

In an embodiment, the core test apparatus 100 may further include a 12V stand-by power source interface 705. The core test apparatus 100 may receive a power signal from an external 12V power adapter via the 12V stand-by power source interface 705 when the core test apparatus 100 is not provided with power signal by the additional power source. The core test apparatus 100 converts the power signal to two power signals: 5V and 3.3V. The 3.3V power signal is used for the processor and the 5V power signal is used for the USB interface, the display apparatus and the like to ensure they operate normally.

In an embodiment, the graphics card is powered by an additional power source via the core test apparatus 100. The additional power source may provide a larger power to the graphics card and is easier to manage. For example, the additional power source may provide a power signal to the graphics card 701 via the first current path or via both of the first current path and the second current path.

In another embodiment, the graphics card 701 may also be powered by the motherboard 702 directly. Fewer devices may be used by powering the graphics card 701 directly by the motherboard, thus saving resources and cost.

The device for testing a graphics card provided by the present invention may minimize the requirement for human intervention and achieve an easy and efficient test of a graphics card. The above device with different features may achieve a plurality of different test functions of the graphics card. Alternatively, the switch among various functions may be implemented by following ways: 1) programming the processor 101 in different manners or 2) programming the processor 101 in a unified manner and then using the buttons on the display apparatus for users to switch manually or using an external computer for users to control the processor. The device in the present invention may also display testing results in real time, which is convenient for users to view the testing results.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as may be suited to the particular use contemplated.

Embodiments according to the invention are thus described. While the present disclosure has been described in particular embodiments, it should be appreciated that the invention should not be construed as limited by such embodiments, but rather construed according to the below claims.

What is claimed is:

1. A device for testing a graphics card, said device comprising:
a core test apparatus, wherein the core apparatus comprises:
a processor configured to perform a test operation on the graphics card; and
a power interface operable to transfer electric energy to the core test apparatus.

2. The device according to claim 1, further comprising an additional test apparatus and wherein the core test apparatus further comprises a first current path including a first galvanometer;
wherein a first power signal is transferred from an additional power source to the additional test apparatus via the first current path;
wherein the additional test apparatus is operable to transfer the first power signal to the graphics card;
wherein the first galvanometer is configured to measure a current of the first power signal; and
wherein the processor is further configured to calculate an input power of the graphics card according to a measured current value of the first power signal.

3. The device according to claim 2, wherein the core test apparatus further comprises a second current path comprising a second galvanometer;
wherein a second power signal is transferred from the additional power source to the graphics card via the second current path; and
wherein the second galvanometer is configured to measure a current of the second power signal.

4. The device according to claim 3, wherein the core test apparatus includes one or more second current paths.

5. The device according to claim 2, wherein the core test apparatus further includes a communication port; and
wherein the processor is further configured to: receive a load current value and a load voltage value from an external load of the graphics card via the communication port; calculate an output power of the graphics card according to the load current value and the load voltage value; and calculate a power efficiency of the graphics card according to the input power and the output power.

6. The device according to claim 2, wherein the core test apparatus further includes a serial bus interface;
wherein the processor is further configured to transfer the input power to an external computer via the serial bus interface to calculate an output power of the graphics card according to a load current value and a load voltage value received from an external load of the graphics card and calculate a power efficiency of the graphics card according to the input power and the output power calculated by the external computer; and
wherein the load current value and the load voltage value are programmed by the external computer.

7. The device according to claim 2, wherein the core test apparatus further includes a serial bus interface;
wherein the processor is further configured to compare the input power with a predetermined power value, and send an instruction to change a voltage of a graphics processing unit on the graphics card to a motherboard via the serial bus interface according to a compared result to obtain a desired voltage; and
wherein the motherboard is communicatively coupled with the graphics card via the additional test apparatus.

8. The device according to claim 2, wherein the core test apparatus further includes a serial bus interface; and
wherein the processor is further configured to compare the input power with a predetermined power value, send an instruction to change a frequency of a graphics processing unit on the graphics card to a motherboard via the serial bus interface according to the compared result to obtain a desired frequency; and
wherein the motherboard is communicatively coupled with the graphics card via the additional test apparatus.

9. The device according to claim 1, further comprising an additional test apparatus;
wherein the core test apparatus further includes a first current path including a first power switch; and
wherein a first power signal is transferred from an additional power source to the additional test apparatus via the first current path;
wherein the additional test apparatus is operable to transfer the first power signal to the graphics card; and
wherein the first power switch is operable to control enable time for transferring the first power signal from the additional power source to the graphics card in accordance with a first control signal from the processor.

10. The device according to claim 9, wherein the core test apparatus further includes a second current path including a second power switch,
wherein a second power signal is transferred from the additional power source to the graphics card via the second current path; and
wherein the second power switch is used to control enable time for transferring the second power signal from the additional power source to the graphics card in accordance with a second control signal from the processor.

11. The device according to claim 10, wherein the core test apparatus includes one or more second current paths.

12. The device according to claim 11, wherein respective control signals allow enable time for transferring respective power signals to the graphics card to be in a desired sequence.

13. The device according to claim 1, wherein the core test apparatus further includes input/output pins for connection with power on headers and/or reset headers on a motherboard communicatively coupled with the graphics card; and
wherein the processor is configured to transfer a I/O signal for controlling a reset operation of the graphics card to the graphics card via the I/O pins.

14. The device according to claim 13, wherein the graphics card is operable to be powered by the motherboard directly.

15. The device according to claim 13, wherein the graphics card is operable to be powered by an additional power source via the core test apparatus.

16. The device according to claim 13, wherein the I/O signal is a programmable pulse signal.

17. The device according to claim 1, further comprising a display apparatus and wherein the processor is configured to output testing information of the graphics card to the display apparatus to be displayed thereon.

18. The device according to claim 17, wherein the display apparatus is configured to display one or more on-screen buttons for adjusting the display of the testing information.

19. The device according to claim 17, wherein the testing information is selected from a group consisting of: an input power, an output power, a power efficiency of the graphics card, and a frequency and a voltage of a graphics processing unit of the graphics card.

20. The device according to claim 1, wherein the core test apparatus further includes an Ethernet interface operable to receive information from an external device and/or transferring testing information of the graphics card from the processor to the external device.

21. An apparatus for testing a graphics card, said apparatus comprising:
a first test device, wherein the first test device comprises:
a processor configured to perform a test operation on the graphics card;
a first current path comprising a first galvanometer; and
a power interface operable to transfer electric energy to the first test device;
an additional power source; and
an additional test device, wherein a first power signal is transferred from the additional power source to the additional test device via the first current path, and wherein the additional test device is operable to transfer the first power signal to the graphics card,
wherein the first galvanometer is configured to measure a current of the first power signal, and
wherein the processor is further configured to calculate an input power of the graphics card in accordance with a measured current value of the first power signal.

22. The apparatus of claim 21, wherein the first test device further comprises:
a second current path comprising a second galvanometer,
wherein a second power signal is transferred from the additional power source to the graphics card via the second current path, and
wherein the second galvanometer is configured to measure a current of the second power signal.

23. The apparatus of claim 22, wherein the first test device comprises a plurality of second current paths.

24. The apparatus of claim 21, wherein the first test device further comprises:
a communication port,
wherein the processor is further configured to:
receive a load current value and a load voltage value from an external load of the graphics card via the communication port;
calculate an output power of the graphics card according to the load current value and the load voltage value; and
calculate a power efficiency of the graphics card using the input power and output power.

25. The apparatus of claim 21, wherein the first test device further comprises:
a serial bus interface,
wherein the processor is further configured to:
transfer the input power to an external computer via the serial bus interface to calculate an output power of the graphics card, wherein the output power is calculated according to load current value and a load voltage value received from an external load of the graphics card, and wherein the load current value and the load voltage value are programmed by the external computer; and
calculate a power efficiency of the graphics card according to the input power and the output power calculated by the external computer.

26. The apparatus of claim 21, wherein the first test device further comprises:
a serial bus interface,
wherein the processor is further configured to:
compare the input power with a predetermined power value,
send an instruction to change a voltage of a graphics processing unit on the graphics card to a motherboard via the serial bus interface according to a compared result to obtain a desired voltage, wherein the motherboard is communicatively coupled with the graphics card via the additional power source.

27. The apparatus of claim 21, wherein the first test device further comprises:
a serial bus interface,
wherein the processor is further configured to:
compare the input power with a predetermined power value;
send an instruction to change a frequency of a graphics processing unit on the graphics card to a motherboard via the serial bus interface according to a compared result to obtain a desired frequency, wherein the motherboard is communicatively coupled with the graphics card via the additional test device.

28. A system for testing a graphics card, said system comprising:
a first test device, wherein the first test device comprises:
a processor configured to perform a test operation on the graphics card;
a first current path comprising a first power switch; and
a power interface operable to transfer electric energy to the first test device;
an additional power source; and
an additional test device, wherein a first power signal is transferred from the additional power source to the additional test device via the first current path, and wherein the additional test device is operable to transfer the first power signal to the graphics card,
wherein the first power switch is operable to control enable time for transferring the first power signal from the additional power source to the graphics card in accordance with a first control signal from the processor.

29. The system of claim 28, wherein the first test device further comprises:
a second current path comprising a second power switch,
wherein a second power signal is transferred from the additional power source to the graphics card via the second current path, and
wherein the second power switch is used to control enable time for transferring the second power signal from the additional power source to the graphics card in accordance with a second control signal from the processor.

30. The system of claim 29, wherein the first test device comprises a plurality of second current paths.

31. The system of claim 30, wherein respective control signals allow enable time for transferring respective power signals to the graphics card to transmit in a desired sequence.
